(19) United States
(12) Patent Application Publication
(10) Pub. No.: US 2013/0019959 A1
(43) Pub. Date: Jan. 24, 2013

(54) Air Valve and Inflatable Device Having the Same

(71) Applicant: Yuan-Tsung Chen, Tainan City (TW)

(72) Inventor: Yuan-Tsung Chen, Tainan City (TW)

(21) Appl. No.: 13/552,809

(22) Filed: Jul. 19, 2012

(30) Foreign Application Priority Data
Jul. 22, 2011 (TW) 100126027

(51) Int. Cl. F16K 15/20

(52) U.S. Cl. 137/223

(57) ABSTRACT

An air valve includes a seat unit having an air passageway and formed with a vent hole in fluid communication with the air passageway, a valve unit operable to block and unblock the air passageway, and a pressure-regulating member disposed on the seat unit. The pressure-regulating member has an engaging portion retained in the vent hole and defining at least one air channel in the air passageway, and a blocking portion blocking the vent hole and movable to unblock the vent hole when the air pressure in the air passageway meets a predetermined condition for permitting air to flow from the air passageway to the external environment via the at least one air channel.

### CROSS-REFERENCE TO RELATED APPLICATION

This application claims priority of Taiwanese Application No. 100126027, filed on Jul. 22, 2011.

### BACKGROUND OF THE INVENTION

1. Field of the Invention

The invention relates to an air valve for an inflatable device.

2. Description of the Related Art

An inflatable device usually includes a main body defining an inflatable space therein, and a valve including a port that is disposed on the main body and that is in fluid communication with the inflatable space, and a stopper that removably blocks the port. During inflation of the inflatable space, the stopper is first removed, and air is introduced into the inflatable space until air pressure inside the inflatable space reaches a predetermined level. Finally, the stopper is replaced to block the port to prevent the air from escaping from the inflatable space. During deflation of the inflatable space, the stopper is removed and the air is expelled from the inflatable space so as to facilitate storage of the device.

During inflation, when the air pressure inside the inflatable space reaches the predetermined level and the stopper has not yet been replaced to the port, the air in the inflatable space would somewhat leak since the predetermined pressure level is generally larger than the atmospheric pressure, thereby resulting in inconvenience to users.

Taiwanese Utility Model No. M336366 discloses a valve that has a closing mechanism capable of blocking the port before detachment of an inflator to thereby overcome the abovementioned drawback. However, once the inflatable device is subjected to a sudden impact when the closing mechanism blocks the port, the sudden rise in inner pressure may result in fracture of the main body or the valve. Moreover, since an air passageway inside this valve is straight, if the inflatable device is inflated by oral inflation, saliva of the inflator would easily enter and accumulate in the inflatable space.

### SUMMARY OF THE INVENTION

Therefore, the object of the present invention is to provide an air valve for alleviating the aforesaid drawbacks of the prior art.

Accordingly, an air valve of the present invention comprises:

a seat unit including a surrounding wall that defines an air passageway, and that has an inner surrounding surface defining a vent hole that is in fluid communication with the air passageway;

a valve unit disposed on the seat unit and operable between an open state, where air communication between the external environment and the air passageway is permitted, and a closed state, where air communication between the external environment and the air passageway via the valve unit is not permitted; and

a pressure-regulating member disposed on the seat unit and having
an engaging portion that is retained in the vent hole, and that cooperates with the inner surrounding surface to define at least one air channel therebetween, and
a blocking portion that is connected to the engaging portion, that blocks the vent hole, and that is movable to unblock the vent hole when the valve unit is at the closed state and when the air pressure in the air passageway meets a predetermined condition for permitting air to flow from the air passageway to the external environment via the at least one air channel.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary exploded perspective view of a first preferred embodiment of an air valve according to the invention;

FIG. 2 is a perspective view of a jacket equipped with the first preferred embodiment;

FIG. 3 is a fragmentary partly sectional view of the first preferred embodiment, illustrating a blocking member at a blocking position;

FIG. 4 is a fragmentary sectional view of the first preferred embodiment;

FIG. 5 is a side view of a pressure-regulating member of the first preferred embodiment;

FIG. 6 is another fragmentary partly sectional view of the first preferred embodiment, illustrating the blocking member at an unblocking position;

FIG. 7 is an exploded perspective view of a second preferred embodiment of the air valve according to the invention; and

FIG. 8 is a perspective view of a sleeping bag equipped with the first preferred embodiment.

### DETAILED DESCRIPTION OF THE PREFERRED EMBODIMENTS

Before the present invention is described in greater detail, it should be noted that like elements are denoted by the same reference numerals throughout the disclosure.

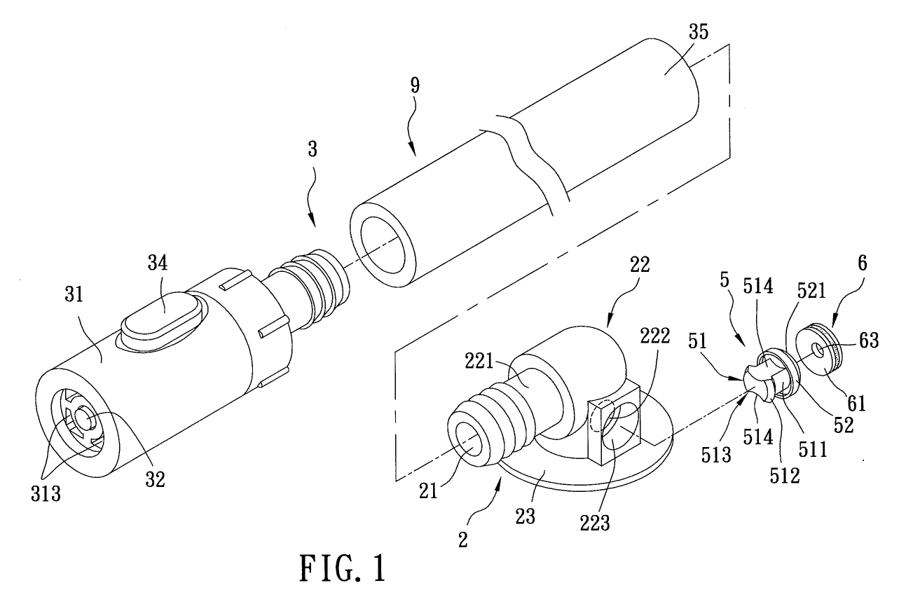

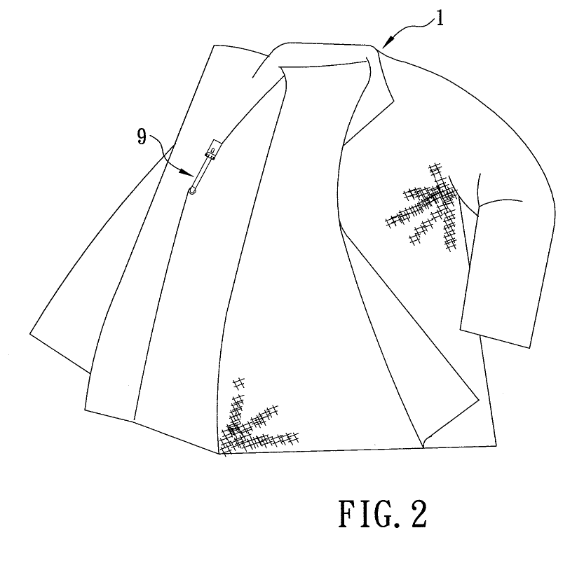

As shown in FIGS. 1, 2 and 3, a first preferred embodiment of an air valve 9 according to the present invention is adapted for use in an inflatable device. In this embodiment, the inflatable device is a jacket having an inflatable body 1 defining an inflatable space 10 therein. The air valve 9 is disposed on the inflatable body 1 and communicates fluidly with the inflatable space 10 via an air hole 11 in the inflatable body 1. The air valve 9 includes a seat unit 2, a valve unit 3 connected to the seat unit 2, and a pressure-regulating member 5 and a stopper 6 disposed in the seat unit 2.

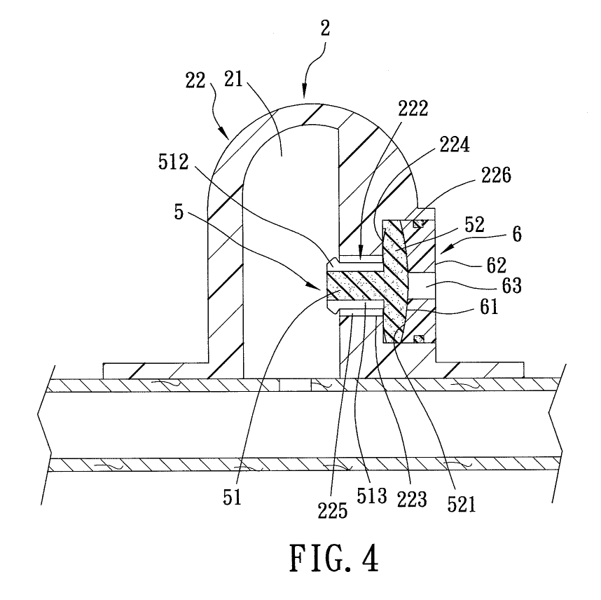

The seat unit 2 includes an L-shaped tubular surrounding wall 22 defining an air passageway 21 that is in fluid communication with the inflatable space 10 via the air hole 11 of the inflatable body 1, and a flange wall 23 extending outwardly from the surrounding wall 22 and secured to the inflatable body 1. The air passageway 21 is L-shaped and has a first section 211 proximate to the air hole 11, a second section 212 spaced apart from and perpendicular to the first section 211 and distal from the air hole 11, and a curved section 213 interconnecting the first and second sections 211, 212. The surrounding wall 22 has a coupling portion 221 corresponding in position to the second section 212 of the air passageway 21, and an inner surrounding surface 223 adjacent to the flange wall 23 and defining a vent hole 222 that is in fluid communication with the air passageway 21. With further reference to FIG. 4 the vent hole 222 has a first hole portion 225 that is proximate to the air passageway 21, and a second hole portion 226 that has a diameter larger than that of the first hole portion 225 and that is distal from the air passageway 21. The inner surrounding surface 223 has a shoulder portion 224 that is disposed between the first and second hole portions 225, 226 of the vent hole 222.

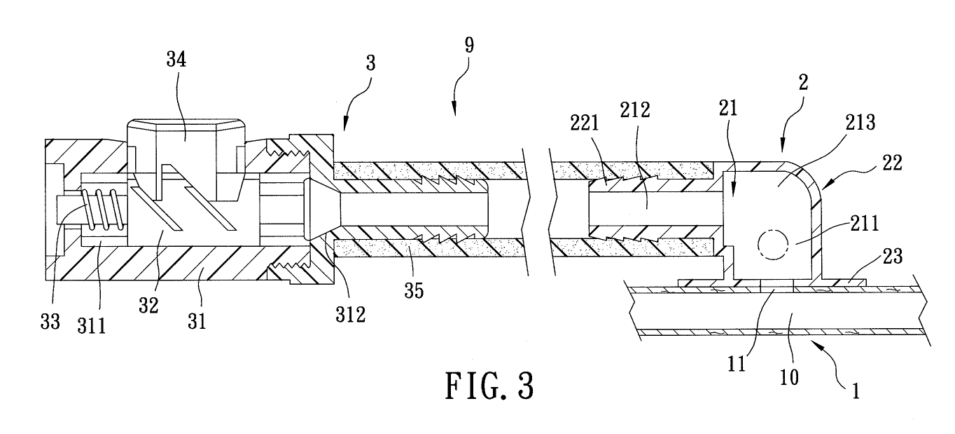

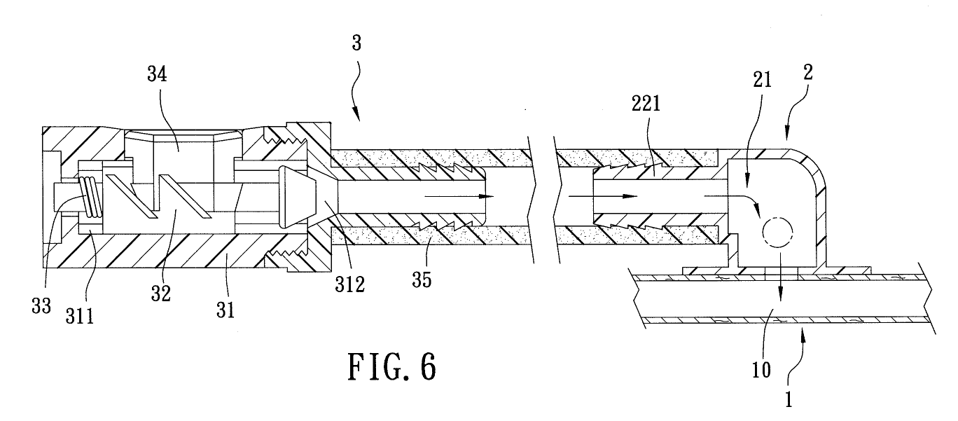

The valve unit 3 includes a casing 31 that defines an inner space 311 therein, and a connecting tube 35 that interconnects the casing 31 and the coupling portion 221 of the surrounding wall 22 and that communicates fluidly the inner space 311 and the air passageway 21. The casing 31 is formed with a communication hole 312 adjacent to the connecting tube 35, and a plurality of inlet holes 313 communicating fluidly the inner space 311 with the external environment. The valve unit 3 further includes a blocking member 32 that is disposed in the inner space 311, and that is movable between a blocking position (see FIG. 3) to block the communication hole 312 such that the valve unit 3 is turned to a closed state and that air communication between the external environment and the air passageway 21 via the inner space 311 and the communication hole 312 is not permitted, and an unblocking position (see FIG. 6), where the valve unit 3 is turned to an opened state and the communication hole 312 is not blocked such that air communication between the external environment and the air passageway 21 via the inner space 311 and the communication hole 312 is permitted. The valve unit 3 further includes a resilient member 33 that is disposed in the inner space 311 and that biases resiliently the blocking member 32 toward the blocking position, and an accessible button member 34 that is operable to move the blocking member 32 toward the unblocking position against a restoring force of the resilient member 33.

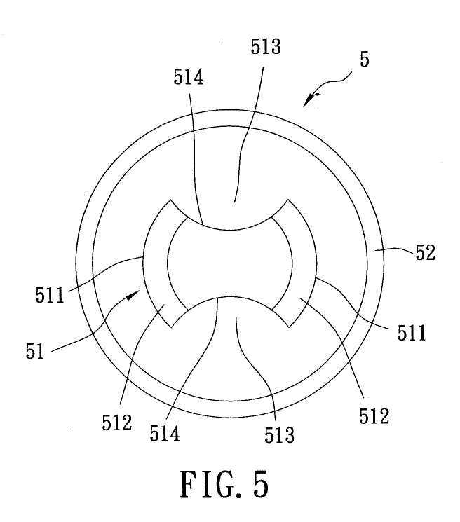

Referring back to FIG. 1 and further referring to FIGS. 4 and 5, the pressure-regulating member 5 is a cork-like block made of rubber or silicone rubber, and has an engaging portion 51 that is retained in the first hole portion 225, and a blocking portion 52 that is connected to the engaging portion 51 and that abuts against the shoulder portion 224 of the inner surrounding surface 223 to block the vent hole 222. The engaging portion 51 has a pair of angularly spaced-apart clinging surfaces 511 clinging to the inner surrounding surface 223, a pair of locking members 512 extending radially and outwardly from the clinging surfaces 511 and abutting against the surrounding wall 22 of the seat unit 2 for affixing the pressure-regulating member 5 in the vent hole 222, and a pair of concaved surfaces 514 disposed alternately with and interconnecting the clinging surfaces 511 and cooperating with the inner surrounding surface 223 to define two air channels 513 therebetween. The blocking portion 52 has a convex surface 521 opposite to the engaging portion 51.

The stopper 6 is made of an elastic material, is disposed fittingly in the vent hole 222, and has a concaved surface 61 that clings to the convex surface 521 of the blocking portion 52 of the pressure-regulating member 5, an outer surface 62 opposite to the concaved surface 61, and a through hole 63 extending through the outer surface 62 and the concaved surface 61.

As shown in FIGS. 3, 4 and 6, when inflating the inflatable device, the button member 34 has to be first pressed such that the blocking member 32 is pushed to the unblocking position. Consequently, air is permitted to flow from the external environment into the inflatable space 10 of the inflatable body 1 via the connecting tube 35 and the air passageway 21 for inflating the inflatable body 1. After inflation, the button member 34 is released such that the blocking member 32 is restored to the blocking position to prevent air leakage from the inflatable space 10.

Once the inflatable body 1 is overly inflated or is subjected to a sudden impact such that the air pressure in the inflatable space 10 is beyond a predetermined condition, the blocking portion 52 of the pressure-regulating member 5 will be deformed by the air to unblock the vent hole 222, and the stopper 6 will also be deformed relative to the pressure-regulating member 5 such that a portion of the air in the inflatable space 10 can be expelled to the external environment via the air channels 513, a gap generated among the blocking portion 52, the inner surrounding surface 223 and the concaved surface 61 of the stopper 6, and the through hole 63. Therefore, the air valve 9 of the inflatable device is capable of preventing a fracture in the inflatable device or accidental movement of the blocking member 32 to the unblocking position due to a sudden impact.

Moreover, when the inflatable device is inflated by oral inflation, saliva of the inflator would be restrained from entering the inflatable space 10 since the air passageway 21 is curved.

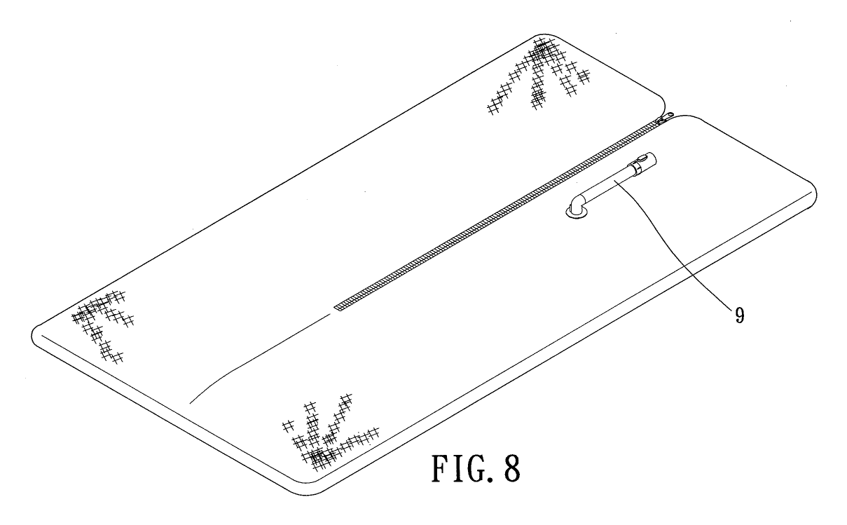

It should be noted that the air valve 9 of this invention may also be equipped in other inflatable devices, such as an inflatable sleeping bag (see FIG. 8).

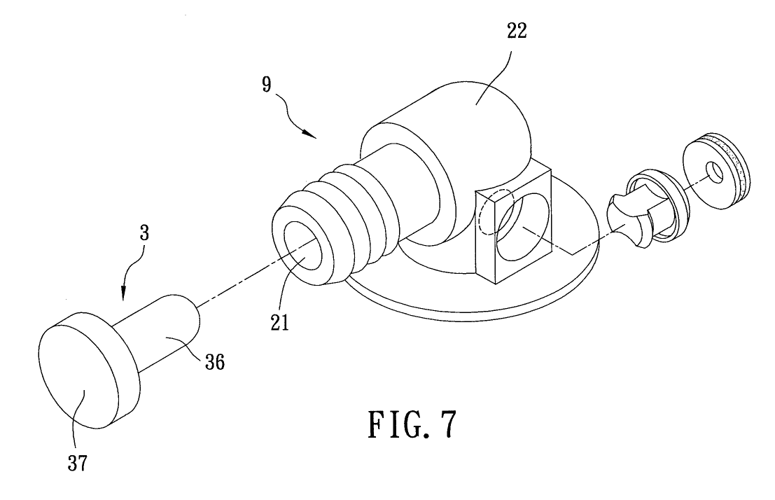

Referring to FIG. 7, an air valve 9 of a second preferred embodiment according to the invention has a structure similar to that of the first embodiment. The main difference between this embodiment and the previous embodiment resides in the configuration of the valve unit 3. The valve unit 3 in this embodiment has an inserting portion 36 inserted removably in the air passageway 21, and an access portion 37 connected to the inserting portion 36 and abutting against an external surface of the surrounding wall 22. The valve unit 3 can be moved from the closed state to the open state by removal from the passageway 21.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An air valve comprising:
a seat unit including a surrounding wall that defines an air passageway, and that has an inner surrounding surface defining a vent hole that is in fluid communication with said air passageway;
a valve unit disposed on said seat unit and operable between an open state, where air communication between the external environment and said air passageway via said valve unit is permitted, and a closed state, where air communication between the external environment and said air passageway via said valve unit is not permitted; and
a pressure-regulating member disposed on said seat unit and having
an engaging portion that is retained in said vent hole, and that cooperates with said inner surrounding surface to define at least one air channel therebetween, and
a blocking portion that is connected to said engaging portion, that blocks said vent hole, and that is movable to unblock said vent hole when said valve unit is at the closed state and when the air pressure in said air passageway meets a predetermined condition for permitting air to flow from said air passageway to the external environment via said at least one air channel.

2. The air valve as claimed in claim 1, wherein said engaging portion of said pressure-regulating member has a pair of angularly spaced-apart clinging surfaces clinging to said inner surrounding surface of said surrounding wall of said seat unit, a pair of locking members extending radially and outwardly from said clinging surfaces and abutting against said surrounding wall of said seat unit for affixing said pressure-regulating member in said vent hole, and a pair of concaved surfaces cooperating with said inner surrounding surface to define two of said air channels.

3. The air valve as claimed in claim 2, wherein:
said blocking portion of said pressure-regulating member has a convex surface opposite to said engaging portion; and
said air valve further comprising a stopper disposed fittingly in said vent hole, having a concaved surface that clings to said convex surface of said blocking portion of said pressure-regulating member, an outer surface opposite to said concaved surface, and a through hole extending through said outer surface and said concaved surface, said stopper being movable relative to said blocking portion of said pressure-regulating member when said blocking portion unblocks said vent hole so as to permit air communication between said air channels and said through hole.

4. The air valve as claimed in claim 1, wherein said vent hole has a first hole portion that is proximate to said air passageway and that corresponds in position to said engaging portion of said pressure-regulating member, and a second hole portion that has a diameter larger than that of said first hole portion, that is distal from said air passageway, and that corresponds in position to said blocking portion of said pressure-regulating member, said inner surrounding surface having a shoulder portion that is disposed between said first and second hole portions of said vent hole and that abuts against said blocking portion of said pressure-regulating member.

5. The air valve as claimed in claim 1, further comprising a stopper disposed in said vent hole and clinging to said blocking portion of said pressure-regulating member at one side opposite to said engaging portion, said stopper being movable relative to said pressure-regulating member when said blocking portion unblocks said vent hole so as to permit air communication between said at least one air channel and the external environment.

6. The air valve unit as claimed in claim 1, wherein said air passageway is curved.

7. The air valve as claimed in claim 6, wherein said valve unit includes:
a casing that defines an inner space therein;
a connecting tube that interconnects said casing and said seat unit and that communicates fluidly said inner space and said air passageway;
a blocking member that is disposed in said inner space and that is movable between a blocking position, where said valve unit is turned to the closed state and air communication between said inner space and said air passageway is not permitted, and an unblocking position, where said valve unit is turned to the opened state and air communication between said inner space and said air passageway is permitted;
a resilient member that is disposed in said inner space and that biases resiliently said blocking member toward said blocking position; and
a button member that is operable to move said blocking member toward said unblocking position against a restoring force of said resilient member.

8. The air valve as claimed in claim 6, wherein said valve unit has an inserting portion inserted removably in said air passageway, and an access portion connected to said inserting portion and abutting against an external surface of said surrounding wall.

9. The air valve unit as claimed in claim 5, wherein said air passageway is curved.

10. The air valve as claimed in claim 9, wherein said valve unit includes:
a casing that defines an inner space therein;
a connecting tube that interconnects said casing and said seat unit and that communicates fluidly said inner space and said air passageway;
a blocking member that is disposed in said inner space and that is movable between a blocking position, where said valve unit is turned to the closed state and air communication between said inner space and said air passageway is not permitted, and an unblocking position, where said valve unit is turned to the opened state and air communication between said inner space and said air passageway is permitted;
a resilient member that is disposed in said inner space and that biases resiliently said blocking member toward said blocking position; and
a button member that is operable to move said blocking member toward said unblocking position against a restoring force of said resilient member.

11. The air valve as claimed in claim 9, wherein said valve unit has an inserting portion inserted removably in said air passageway, and an access portion connected to said inserting portion and abutting against an external surface of said surrounding wall.

12. An inflatable device comprising:
an inflatable body defining an inflatable space therein; and
an air valve disposed on said inflatable body, and including
a seat unit that includes a surrounding wall defining an air passageway that is in fluid communication with said inflatable space, said surrounding wall having an inner surrounding surface defining a vent hole that is in fluid communication with said air passageway,
a valve unit disposed on said seat unit and operable between an open state, where air communication between the external environment and said air passageway via said valve unit is permitted, and a closed state, where air communication between the external environment and said air passageway via said valve unit is not permitted, and
a pressure-regulating member that is disposed on said seat unit and that has
an engaging portion retained in said vent hole, and cooperating with said inner surrounding surface to define at least one air channel therebetween, and
a blocking portion connected to said engaging portion, blocking said vent hole, and movable to unblock said vent hole when said valve unit is at the closed state and when the air pressure in said air passageway meets a predetermined condition for permitting air to flow from said air passageway to the external environment via said at least one air channel.
